(19) United States
(12) Patent Application Publication
(10) Pub. No.: US 2015/0178532 A1
(43) Pub. Date: Jun. 25, 2015

(54) WEARABLE RFID STORAGE DEVICES

(71) Applicant: David Allen Brulé, Ottawa (CA)

(72) Inventor: David Allen Brulé, Ottawa (CA)

(21) Appl. No.: 14/408,740

(22) PCT Filed: Jun. 20, 2013
(86) PCT No.: PCT/CA2013/050473

§ 371 Date: Dec. 17, 2014

Related U.S. Application Data
(60) Provisional application No. 61/662,172, filed on Jun. 20, 2012.

(51) Int. Cl. G06K 7/10; G06Q 20/32; H01Q 7/00; H05K 3/46; G06K 19/077; G06K 19/07; E05B 49/00; G07C 9/00; H01Q 1/22

(52) U.S. Cl. CPC G06K 7/10415; G07C 9/00309; G07C 9/00111; G06Q 20/3278; H01Q 7/00; H01Q 1/2216; G06K 19/07762; G06K 19/0723; E05B 49/00; H05K 3/4611; G07C 2009/00317

(57) ABSTRACT

Systems, methods, and devices related to a multifunctional digital data storage device which is wearable by the user as a decorative ornament. A wearable device, such as a ring or a wristwatch, is equipped with a transceiver, a storage module, and an antenna. The storage module contains identification data, financial information, and other data which may be used to activate accounts, open digital locks, make payments for transactions at retailers, as well as facilitate other transactions. The device may also be provided with other capabilities such as a heart rate monitor.

### TECHNICAL FIELD

The present invention relates to wearable wireless storage devices. More specifically, the present invention relates to a multifunctional wearable storage device which can be used to store a user's financial information, and which can be used to activate or actuate an assortment of specifically designed locking devices.

### BACKGROUND

The computer and communications revolution of the early 21^{st} century has given the world numerous advancements that have made life easier and more convenient for the common man. However, these advancements and the devices and enhancements they bring have also made life, in some senses, more complicated as well. Differing technologies as well as the different requirements for these technologies now require that a person have multiple devices, cards, and accoutrements to have the convenience that technology brings.

Smart cards have become ubiquitous due to the boom in cell/mobile phone technology and their adoption by major credit card companies and retailers. Although a single smart card can be programmed with multiple banking credentials, medical information, as well as other personal identification information, they are usually only associated with the provider of the card. The consequence of this is that one must necessarily carry multiple cards. One of the biggest drawbacks of smart cards is that they must be carried in a pocket, wallet, purse or other container, thereby increasing the likelihood of the card or cards being forgotten at home, lost, or stolen. Because of how the cards must be carried, a specific card may be missing for several days to several weeks before its absence is noticed. Usually its absence is noted at the most inopportune time—the next time that specific card is needed. This potential delay in cancelling and replacing the lost card significantly increases the risk of incurring liability for unauthorized use during this time period.

Another technology that makes life easier but requires another device for us to carry is the wireless communications technology broadly known as Bluetooth. Bluetooth-based wireless headsets provide an extremely useful hands-free capability for today's mobile phone user, allowing a user to not have to locate his phone in a purse, briefcase, or jacket pocket in order to answer or make a call. However, as is the case with almost any electronic device, for Bluetooth headsets to be useful, they must not only be charged but they must also be carried by the user. Though some headsets are quite small, even the smallest headset still occupies storage/carrying space when not in use. As well, since the headsets must be charged, most people need to have access to cables and power adapters to ensure that the headsets can be charged in case their charge runs out at an inopportune moment. Furthermore, unless one is willing to constantly wear the headset, the headset still needs to be located when receiving a call.

Another technology that has made today's modern life more convenient is that of computer pointing devices. These devices have made computers much more user-friendly and, consequently much more useful. Computer pointing devices, such as a mouse, track ball, track pad, joystick control the position of a cursor on a computer display. One drawback is that they often require the user to move his hands off the keyboard in order to move the cursor to a different position.

Remote controls for the various home and entertainment devices that are the mainstay of today's living room or den is another technology that has made life simpler for the modern man. No longer does one have to walk over to a television set, stereo system, or any other audio-visual (A/V) device to change a channel, change the volume, or adjust some other setting. These actions can now be done from the comfort of the sofa or the bed and away from the actual device. However, it is common for remote control devices to be hand held and, consequently, to be left near the A/V equipment when not in use. This raises the risk of the remote control devices being dropped, misplaced, lost, or having their batteries drained due to lack of use, thereby rendering them unusable. Another drawback is in the physical layout and incompatibility of the various remote control devices. Not only is each manufacturer's remote control layout unique as to the size, placement and function of buttons, remote control devices are often different even across different versions of the same or similar product from the same manufacturer.

It should be noted that even though the inconsistency of layouts drawback is somewhat addressed by the use of a hand held universal remote, universal remotes also suffer from the risk of being dropped, misplaced, lost or having no power when needed.

Another technology that has helped modern man cope with not just the world but his own mortality is that of the heart rate monitor. There are a plethora of heart rate monitors currently available. All are designed for transitory or temporary use and subject to movement artifacts. The most common style, consisting of a chest mounted strap transmitter coupled with a wrist mounted receiver, requires the user to partially disrobe in order to install the strap across the chest, with the result that this type of monitor is only practical during physical exercise or training.

Another technology that helps the modern world run is that of keyless entry using keycards or similar touchless means. Such a technology has done away with the need for physical keys for locks. However, this technology still requires users to carry separate keycards, fobs, and other devices for each lock that needs to be accessed. As can be imagined, the plethora of devices can cause confusion and inconvenience to the user.

Based on the above, there is therefore a need for systems, methods, and devices which mitigate if not overcome the shortcomings of the prior art.

### SUMMARY OF INVENTION

The present invention provides systems, methods, and devices related to a multifunctional digital data storage device which is wearable by the user as a decorative ornament. A wearable device, such as a ring or a wristwatch, is equipped with a transceiver, a storage module, and an antenna. The storage module contains identification data, financial information, and other data which may be used to activate accounts, open digital locks, make payments for transactions at retailers, as well as facilitate other transactions. The device may also be provided with other capabilities such as the capability to operate as a heart rate monitor, a Bluetooth-enabled mouse, a universal remote, or a Bluetooth-enabled headset.

In a first aspect, the present invention provides a device for storing information, the device comprising:
a nonvolatile storage medium for storing digital information;
a antenna for receiving and transmitting the information;
transceiver circuitry for receiving and transmitting the information using the antenna;
a housing for containing the storage medium and the circuitry, the housing being constructed and arranged as an ornament to be worn by a user;
wherein
the device only transmits the information when the circuitry is activated by a signal received from a preconfigured reader device.

In a second aspect, the present invention provides a method for receiving payment for a transaction, the method comprising:
a) activating a device used by a user paying for the transaction, the device being activated by a proximity of the device with a reader for the device;
b) retrieving from the device information relating to an identity of the user including an amount of funds available to the user for the transaction;
c) connecting to a remote server and verifying the identity of the user and the amount available to the user;
d) determining if the amount available is suitable for the transaction
e) in the event the amount is suitable,
   e1) sending instructions to the remote server to subtract costs for the transaction from the amount available to the user;
   e2) sending instructions to the remote server to transfer an amount equal to the costs to a specific merchant's account from the user's account;
   e3) subtract costs for the transaction from the amount available to the user and update the information on the device to reflect the costs of the transaction;
      wherein
the device comprises:
   a nonvolatile storage medium for storing digital information;
   a antenna for receiving and transmitting the information;
   transceiver circuitry for receiving and transmitting the information using the antenna;
   a housing for containing the storage medium and the circuitry, the housing being constructed and arranged as an ornament to be worn by a user;
the device only transmits the information when the circuitry is activated by a signal received from a preconfigured reader device.

In a third aspect, the present invention provides a lock system comprising:
an optional interior touch activated switch;
an exterior touch activated switch;
activation circuitry for activating and communicating with a device using wireless communications, the device being for transmitting a digital key to the lock system when the device is activated;
processing circuitry for receiving the digital key and determining if the digital key is an expected digital key;
a lock, the lock being locked and/or unlocked by a motor or solenoid, the motor or solenoid operating the lock when the processing circuitry determines that the digital key is an expected digital key.

In a fourth aspect, the present invention provides a method for unlocking a lock, the method comprising:

a) activating a digital storage device for unlocking the lock when the device is in physical proximity of the lock;
b) querying the storage device for an expected identifier;
c) receiving a received identifier from the device;
d) comparing the received identifier with the expected identifier;
e) in the event the expected identifier matches the received identifier, unlocking the lock;
f) in the event the expected identifier does not match the received identifier, maintaining a locked status of the lock;
wherein the device communicates with the lock in a wireless manner.

In another aspect of the invention, the present invention provides an antenna assembly comprising:
a flat spiral wire loop;
a central area encircled by said wire loop, said central area being devoid of said wire loop;
   wherein said central area is configured to operate as a capacitive touch sensor and wherein said central area is unconnected to said wire loop.

Yet a further aspect of the invention provides an electronically unlockable lock comprising:
a flat spiral wire loop operating as an antenna;
a central area encircled by said wire loop, said central area being devoid of said wire loop;
   wherein
said central area is configured to operate as a capacitive touch sensor;
said central area is unconnected to said wire loop;
said central area is used for unlocking said lock.

A further aspect of the invention provides a method for assembling a multi-layered flexible circuit based device, the method comprising:

a) placing a plurality of layers atop one another to form a web, said plurality of layers including a flexible circuit and an outer lamination;
b) offsetting at least one of said layers such that layers overlap and a portion of at least one layer is exposed from other layers;
c) providing an excess flap of said flexible circuit and said outer lamination after said offsetting;
d) rolling overlapped layers to result in a tube with said flap being exposed from said tube;
e) closing said flap after said flexible circuit has been tested;
wherein
said flap is used for testing and tuning said circuit prior to step e).

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a picture of an example implementation of the system detailed in FIG. 1;

FIG. 3 is a block diagram of a lock system which operates in conjunction with the system in FIG. 1;

FIG. 3A illustrates the various parts of the lock system and how the system operates with the system in FIG. 1;

FIG. 3B is a block diagram of an automobile variant of the lock system in FIG. 3;

FIG. 3C illustrate deadbolt and conventional door handle implementations of locks which may be used with the lock system in FIG. 3;

FIG. 3D illustrate conventional door handle and deadbolt implementations of an operating mode control switch which may be used with the lock system of FIG. 3;

FIGS. 3E and 3F illustrate a padlock embodiment of one aspect of the invention;

FIG. 4 is a system block diagram of a ring implementation of the system in FIG. 1;

FIG. 5 is a schematic diagram of the components of the RFID portion of the device in FIG. 4;

FIG. 6 illustrate mechanical drawings showing the top, bottom, and side views of the flexible circuit for the device in FIG. 4;

FIG. 7 illustrates how the loop antenna in the ring implementation of the device is formed;

FIG. 8 is a side cut-away view of the ring device;

FIG. 9 is a flowchart detailing the steps for paying for transactions using the device;

FIG. 10 illustrates the offset lamination alignment for an individual ring circuit prior to being rolled into a ring;

FIG. 11 shows the offset alignment for multiple circuits in a web to be used in a roll to roll process

FIG. 12 diagrams the roll to roll web as it is rolled to form multiple rings; and

FIG. 13 shows both a roll to roll web after it is rolled into a number of rings and the multiple rings completed afterwards.

### DETAILED DESCRIPTION

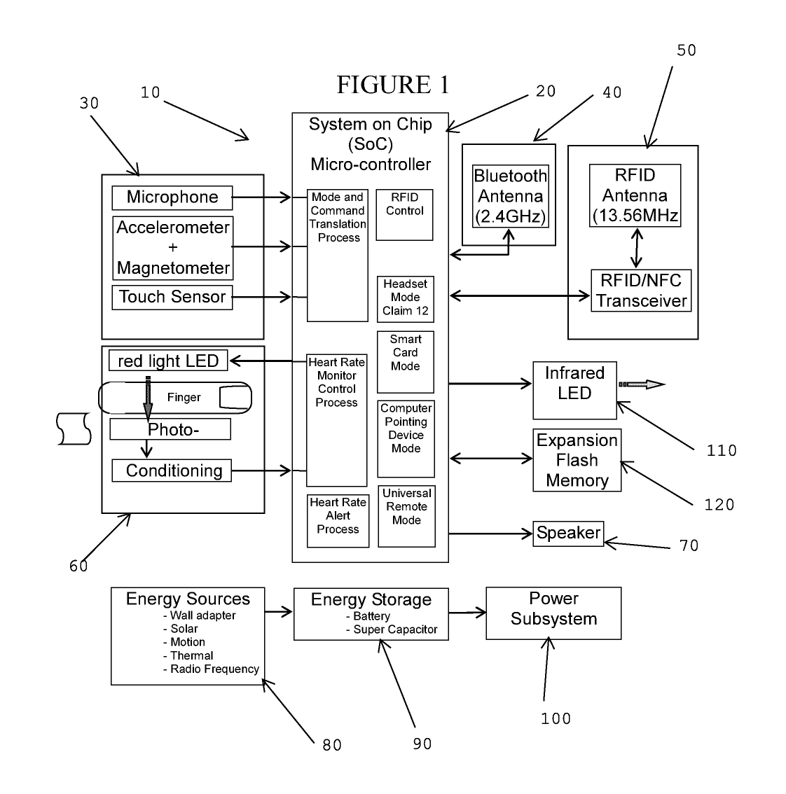

Referring to FIG. 1, a block diagram of a device according to one aspect of the invention is illustrated. The system 10 of the device includes a microcontroller 20, an input/output block 30, a Bluetooth antenna 40, an RFID block 50, a sensor block 60 for a heart rate monitor, and a speaker 70. Energy sources 80 feed an energy storage module 90 which is drawn upon by a power subsystem 100. Also part of the device is an infrared LED 110 and, optionally, an expansion flash memory 120 for further storage.

The microcontroller 20 operates and executes the various processes required by the various modes, subsystems, and functions of the device. As can be seen, the device can operate as an RFID (radio-frequency identification) device using the RFID antenna and the RFID/NFC (near field communication) transceiver in the RFID block 50. As an RFID device, the device may be used to, among others, open locks, provide access to secure resources (e.g. computers, networks, locks, etc.), and provide the user with the ability to pay for transactions at retailers. The device can also operate as a heart rate monitor using the sensor block 60 and the heart rate monitor control process and the heart rate alert process executed by the microcontroller 20. Operating as an equivalent to a smart card, the device can use the RFID 50 to communicate with smart card readers. The input/output block 30 (which includes a microphone, an accelerometer/magnetometer, and a touch sensor) can be used when the device is in its computer pointing device mode or in its universal remote mode. When in the pointing device mode, the device can be used as a mouse replacement. When in the remote mode, the device can be used in lieu of a remote control for A/V equipment. The infrared LED 110 or the Bluetooth antenna 40 can be used for the pointing device mode or the remote mode.

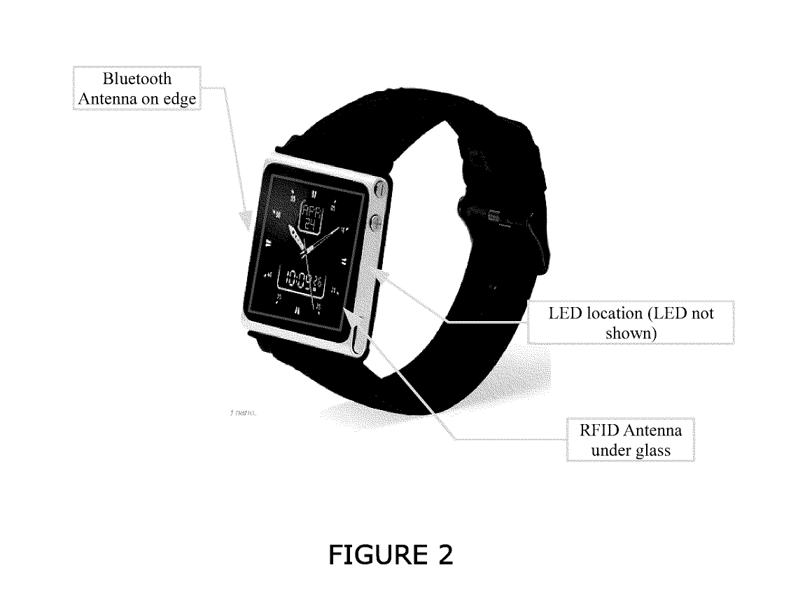

The device whose components are detailed in FIG. 1 may take the form of an ornamental piece of jewelry which may be worn by a user. In one implementation, the device has a housing that takes the form of a wristwatch and actually functions as a wristwatch in conjunction with its other functions. Referring to FIG. 2, an example implementation of the device, in the form of a wristwatch, is illustrated. As can be seen from the Figure, the Bluetooth antenna may be placed at the edge of the watch while the RFID antenna can be placed underneath the glass face of the watch. A simpler ring implementation of the device is described and illustrated below.

The device may operate in modes which correspond to specific functions as detailed below. Some modes below may use hand/finger gestures for controlling aspects of that particular mode.

Mouse Control Mode—The mouse control mode may run in the background and may be initiated when a paired Bluetooth session, associated with the mouse profile, starts. If the device has been previously paired with a suitably controllable computer, TV, or other similar apparatus, the device can be used to control the apparatus. The function may be configured to become active once within range of the controllable apparatus, but can be enabled or disabled at any time. This mode may use the motion of the finger for control. The finger's motion is tracked using the accelerometer and electronic compass, single and double taps are detected, and scrolling up and down may be effected by spinning the finger clockwise or counter clockwise.

Home Automation Mode—When connected to a home automation server, the device may be used as a controller for this system. This mode may be used for turning off/on/dimming lights, locking the house, changing environmental conditions, etc. A control scheme may use finger swipes and gestures.

Universal Remote Mode—When in the universal remote control mode an IR LED on the device may be used to control legacy IR based systems using finger and hand gestures.

Headset Mode—when the device has been paired with a suitable cellphone, smartphone or computer with a Bluetooth headset profile, the device can be used for voice communications. In one configuration, an incoming call activates the device and the device vibrates for an incoming call. In this configuration, the device's microphone and speaker is used with the Bluetooth connection to give the user the capability to answer telephone calls. As an example for a control scheme for this mode, the user may raise his finger to his ear may answer an inbound call or the user may activate the mode for an outbound call. Also, the user may tap the ring after turning his finger in a clockwise or counter clockwise motion to trigger a change in volume.

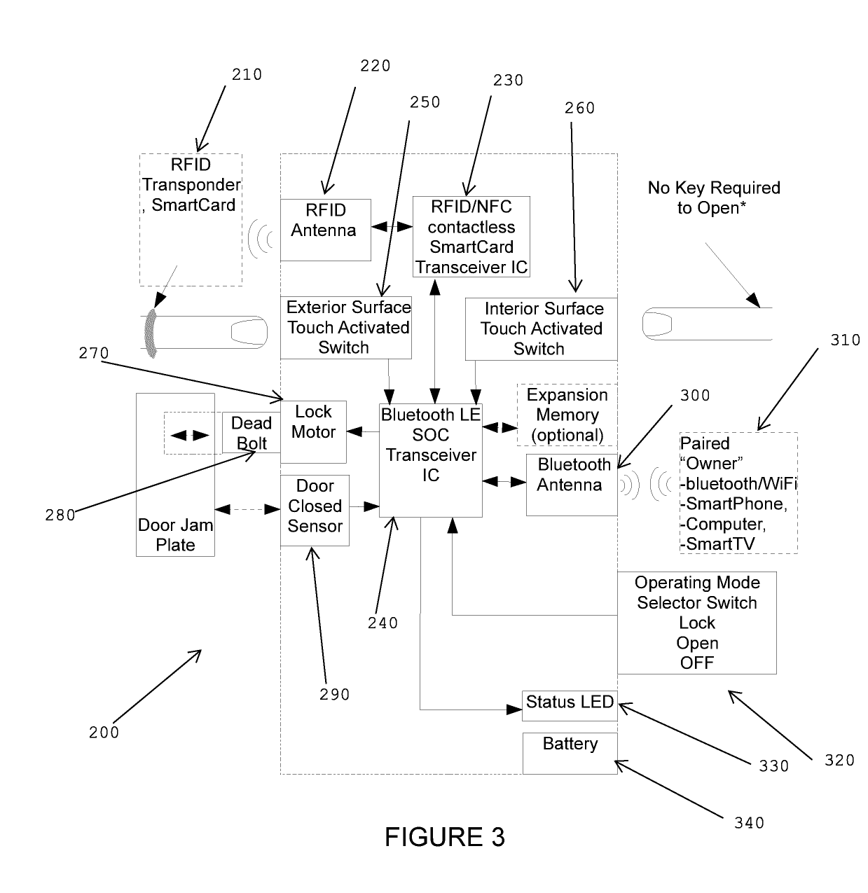

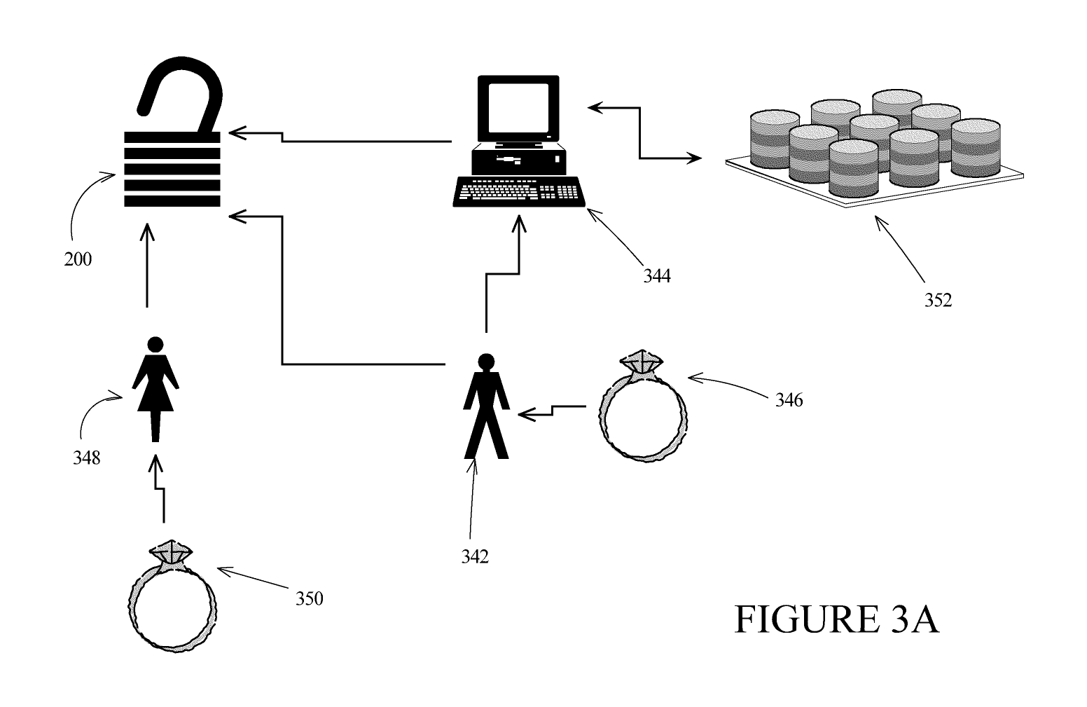

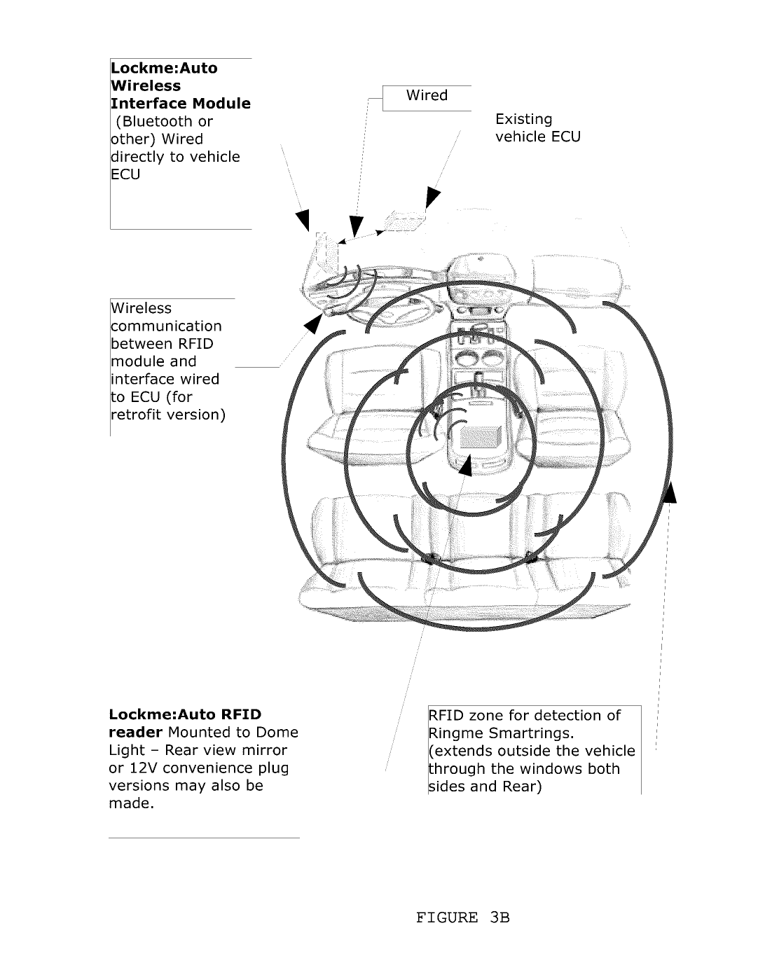

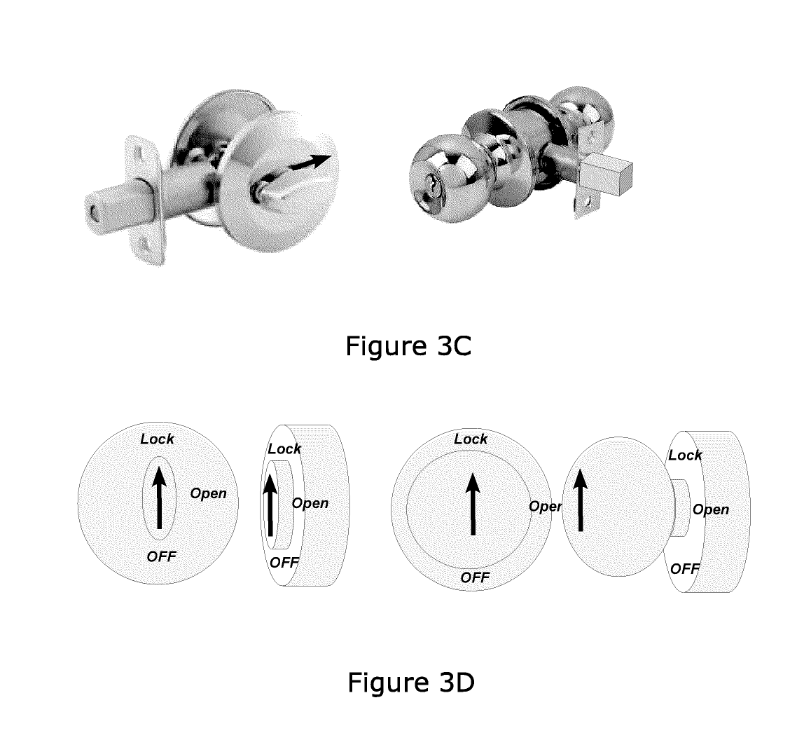

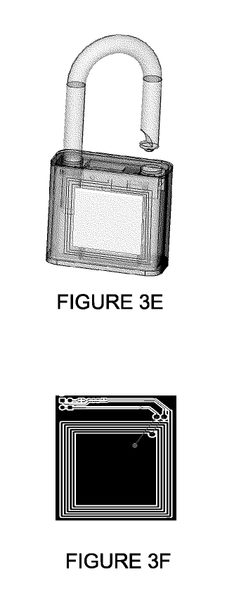

Referring to FIG. 3, a block diagram of another system that works with the device is illustrated. The lock system 200 in FIG. 3 can be unlocked using the RFID function of the device. When the RFID transceiver on the device is activated by the RFID subsystem on the lock, the device transmits a digital key. If the digital key matches one of the digital keys stored in the lock, the lock unlocks and access is granted to the user.

The lock system 200 operates in conjunction with an RFID transponder 210 that may be present in the device as explained above. An RFID antenna 220 in the lock system 200 receives signals from the transponder 210 and these signals are interpreted as a digital key by the RFID/NFC transceiver 230. The SOC (system on a chip) 240 (which also operates as a Bluetooth transceiver) then determines if the digital key matches one of a number of expected digital keys. If there is a match, the lock may be unlocked once one of the touch activated switches (including the exterior touch activated switch 250 or the interior touch activated switch 260) is activated. When the lock is unlocked and activated, the SOC 240 activates a lock motor 270 that withdraws a deadbolt 280. A door closed sensor 290 can be used to determine when the door is closed and the lock is active. As an example, when the door is closed, the lock may automatically extend the deadbolt to lock the door. Other means other than the motor for locking and unlocking the lock may be used.

It should also be noted that the lock system may be configured so that the touch activated switches initiate the communications with the device. As such, a user would activate the touch switch and only then would the lock system communicate with the device to determine if the device has a suitable digital key.

In addition to the above-noted components, the lock system 200 also has a Bluetooth antenna 300 which operates in conjunction with a suitable Bluetooth system 310 external to the lock system as will be explained below. An operating mode switch 320 is also present and operates with the SOC 240 to set the operating mode of the lock system as detailed below. A status LED 330 which shows the status of the lock system and a suitable power supply (a battery in this instance) 340 are also present. Depending on the implementation, the lock system may also be equipped with connectivity options such that a USB flash drive may be used with the lock system. The USB flash drive may be used to transfer data to and from the lock system's data storage.

The lock system improves on capabilities currently provided by powered, access card controlled, door locks. The lock system is mostly dormant, requiring minimal power when not in use, and yet provides a means of “keyless” entry. Users can activate and unlock the lock without having to remember and punch in codes or having to carry and locate keys or access cards. Lock activation is achieved by simply touching the touch activated switch while the user is equipped with the device. A latching or traditional door knob is not required but such a door knob may be used for aesthetic reasons.

Regarding the lock system's power needs, Bluetooth Low Energy (LE) technology may be used to lower the lock system's power consumption when not in use. And, to further assist the lock system's power requirements, the lock system may be configured such that its battery is charged with a photo cell on the exterior surface. The lock system's touch activated switches and its other components may require minimal power when not in use. A small current may be required to allow the Bluetooth LE SOC to power up once a second to look for a touch input, or to keep capacitors in the touch activated switches charged. This small amount of current may be easily handled by a photocell exposed to ambient light trickle charging a small battery all day long. Preferably, the battery is sized to provide a month or more of operation even in complete darkness. Such a scheme would ensure that the battery was always charged and ready for use.

The lock system is programmed to respond to the unique code embedded or stored in the device detailed in FIG. 1. During installation, a main user of the lock system assigns his device as the owner or main user of the lock system via a pairing procedure using a suitable wireless communications protocol with external computing apparatus such as a smartphone, computer, or the like. A suitable wireless communications protocol may be Bluetooth 4.0, WiFi, or any wireless protocol with suitable security provisions. Once a pairing is accomplished between the lock system and the external computing apparatus, the main user may register the lock system with an entity that provides online storage/backup services. The main user's passkey or digital key (specific to the lock system) as well as other digital keys and devices which have been registered to operate the lock system may then be securely stored and registered with the online storage/backup. Alternatively, the main user may store the relevant digital keys using another method. For this use, the lock system may be controlled using a local database. When the lock system is wirelessly connected to the main user's computing apparatus, the main user may add new digital keys and/or registered devices, modify access for existing keys and devices, and transfer ownership of the lock system.

The main user may transfer ownership of the lock system by assigning ownership to another device. The main user has the ability to grant master digital keys (i.e. similar to a master key) and assign temporary digital keys. A digital master key, once granted, belong to the device they have been granted to and cannot be removed without the permission of the user of the device. This can be achieved by an email request which must be accepted by the owner of the granted master key.

Temporary keys may be granted to a specific device for a specific period of time or the temporary key may be granted for an indefinite period of time. The difference between a master key and a temporary key assignment is that the temporary access may be removed from the lock system at any time by the main user while a master key requires the owner of the master key to relinquish his key.

In all of the above cases the device's unique code (i.e. the digital key), associated email address and personal ID of each device, are stored locally in the lock system's non-volatile memory. The device does not contain any lock information—an unauthorized user may not reverse engineer the information on the device to determine which locks work with the device. As a safety feature, if any device with unrecognized digital keys attempts to operate the lock system, any personal ID available on the unrecognized device is retrieved and stored on the lock system. This data can then be downloaded or transferred to a suitable computing device for review by the main user. The unrecognized digital keys and devices can then be reviewed by the main user. In one implementation, the data may be transferred to a suitable flash or USB drive or it may be transferred using the Bluetooth capability of the lock system.

As noted above, rotating door knobs are not required to open the door equipped with the lock system. While these knobs may be used for aesthetic reasons, door handles or knobs are mounted on one or both sides of the housing. In one implementation, the touch activated switch 250, 260 may form part of the knob such that grasping or touching the knob or handle activates the lock system. It is recommended that a handle be located on the swing-in side of the door, unless the door opening and closing is planned to be completely automatic.

### Lock System Modes of Operation:

All versions of the lock system can be set to operate in four different modes and programmed for different behaviour depending on the time: Open, Locked, Off, and Controlled passage. Other modes may be possible.

Other than Controlled passage, the modes of operation may be set manually using the position of the operating mode selector switch 320. The switch 320 may be incorporated into a thumb latch (for a deadbolt implementation) or a door handle for a door handle implementation (with the position of the door handle indicating the mode of operation). Alternatively, the operating mode selector switch may be implemented in a standard door knob lock switch instead of using the position of the actual door knob. This implementation may avoid the issue of the user inadvertently changing the operating mode while opening or closing the door while grasping the door knob.

For a deadbolt implementation, the position of the selector switch, be it in Open, Locked, or Off position, can be set by the position of the thumb latch, resulting in the lock system behaving in a manner similar to a manual deadbolt. The clearly viewable position of the thumb latch informs the user of the lock system's mode. This allows the user to be aware, at a glance, if the door is locked properly.

The various modes of operation function as follows:

Open Mode:

The device with its RFID function is not required for ingress or egress and the lock will open for a programmable amount of time (e.g. 3-5 sec) when either interior or exterior touch panels or handles are touched, regardless of whether a valid digital key is detected. Once the door is closed, the latch re-engages and cannot be opened again until the handle is released.

Locked Mode:

For ingress, a valid device must be recognized and its valid digital key must be received. In one implementation, to receive the digital key, the lock must be activated by touching the exterior touch panel or the door handle. Once a valid digital key is received, the lock unlocks. However, a suitable device and its valid digital key is not required to activate the lock system from the interior. Touching or activating the interior touch panel will activate or open the lock. This is done to allow for the emergency exit of people who may not have valid digital keys or devices.

Off Mode:

Turns off the locking mechanism of the lock system completely. If the door is closed at the time (or if the deadbolt is extended), the lock cannot be opened until the mode is exited. If the door is open at the time the mode is entered (or if the deadbolt is retracted), the latch or deadbolt remains retracted and the lock cannot be latched or engaged. It should be noted that this mode only affects lock behaviour. Any attempts at accessing the lock system and other log information are still collected. As well, Bluetooth communications is still possible while in this mode.

Controlled Passage Mode:

a valid device and its valid digital key must be recognized to operate the lock system using either the interior or exterior touch panels or handles. Thus, the lock system cannot be unlocked from either side without a valid device and its valid digital key. This mode can only be set and unset by the main user of the lock system via the Bluetooth-enabled (or wireless communications enabled) programming.

It should be noted that although the description of the lock system details a door lock implementation, a simplified version, useful as a padlock or useful for safes and the like, is also possible. Such an embodiment would only have an exterior touch activated switch or panel. In addition to the above, the lock system may be implemented to provide access to electronic apparatus (e.g. computer systems, tablets, computer networks, etc., etc.) such that users who do not have an authorized device and an authorized digital key will be unable to operate the apparatus. Instead of a motor to operate a deadbolt, such an implementation would have circuitry or software that prevents access to the apparatus if the relevant digital key is not received by the lock system.

Referring to FIG. 3A, a schematic diagram illustrating the various parts of the lock system and how it operates in conjunction with the device is shown. The lock system 200 is associated with a main user 342. The main user, using a suitable computer or computing device 344 sets a digital key that resides in the lock system 200. The digital key is used to unlock the lock system 200. The device 346, worn by the main user 342, has the digital key stored on it. The main user 342, when physically approaching the lock system 200, will have the device 346 automatically activated and the digital key will be communicated to the lock system 200. If the digital key from the device matches the digital key stored in the lock system, then the lock system can be unlocked. If the digital keys do not match, the lock system will not be unlocked.

It should be noted that the main user 342 may grant a secondary or temporary digital key to a second user 348 who uses (or wears) a second device 350. The secondary digital key is also stored on the second device 350. All the digital keys created by the main user for the lock system 200 may be backed-up by the computing device 344 to an online server or server farm 352.

For clarity, FIGS. 3C, 3D, 3E and 3F illustrate embodiments of the invention. FIG. 3C show deadbolt and conventional door handle implementations of the locks which may be used with the invention. FIG. 3D illustrate deadbolt and door handle implementation of an operating mode control switch. FIGS. 3E and 3F illustrate details of a padlock implementation of one aspect the invention. As can be seen from the Figures, the padlock has at least one flexible circuit-based RFID (radio frequency identification) rectangular spiral trace antenna placed to a flat external surface of the padlock. The spiral trace antenna is placed to leave a central area vacant. This central vacant area, as well as other non-grounded conductive areas can be configured to operate as a capacitive touch sensor. These capacitive touch activation areas can be used as the exterior touch activated panel described above. In addition to the central vacant area, other external parts of the padlock not occupied by the RFID spiral trace antenna (e.g. the sides of the padlock) can be connected and can similarly act as a capacitive touch sensor. Preferably, the vacant areas can be coupled to an I/O pin of a microcontroller inside the padlock so that the vacant areas can operate as a touch sensitive sensor switch. Of course, suitable software would control the behavior of the vacant areas so that the vacant areas can operate as a touch sensitive switch. It should be noted that, in one variant, vacant external areas of the padlock may be occupied by a solar cell (not shown). The solar cell can be configured to trickle charge a battery embedded in the device.

It should be noted that the padlock illustrated in FIGS. 3E and 3F is a conventional padlock with the exception of the antenna and the electronics inside the padlock. The shackle and its parts are conventional and, depending on the implementation, tumblers and pins may be used internally. However, instead of a key moving the tumblers and the pins, a motorized mechanism may be used to unlock the shackle.

A variant of the lock system described above is designed for use with vehicles. This vehicle variant may be programmed in a manner similar to the lock system described above and may share similar capabilities, configurations, and functions. Thus, a main user of the vehicle variant is allowed to “pair” his computer system with the vehicle variant and can access to different instances of the device, can transfer ownership, create temporary keys, etc. FIG. 3B illustrates some of the features of such an implementation.

In one implementation, the vehicle variant has a main RFID reader module mounted on the interior ceiling of the vehicle (similar to an interior convenience light), with the module being wired for +12V power. A simplified installation may allow for the module to be integrated into a 12V power plug and be plugged into an available 12V jack, as long as the jack is powered even when the vehicle is off. As an alternative, the main RFID reader module may be located on the rear view mirror of the vehicle.

This vehicle variant may be integrated with the vehicle's engine control unit (ECU) as well as the vehicle's computer system and wiring. Alternatively, the vehicle variant may be available as a retrofit package for existing vehicles.

For retrofit applications, an additional Bluetooth Low Energy (BLE) module or other similar wireless interface may be wired to the vehicle's computer system. This would provide a wireless interface between the main RFID reader module and the vehicle's computer. The main RFID reader module can thus be positioned at a location that provides the best coverage without requiring excessive installation time and effort.

The main RFID reader module activates (i.e. seeks nearby valid devices) at a programmable rate (likely once a second). The module has an antenna and sufficient radiated power to energize and read the unique digital keys of any device in or near the vehicle (e.g. within 5 feet of the vehicle).

If the vehicle variant identifies a valid device, all entry points as well as the ignition system will unlock and any alarm will be deactivated. Essentially, as the user with the valid device approaches the vehicle, the vehicle unlocks without the user having to do anything except continue having possession of the device.

The vehicle variant operates such that as long as a valid device is identified near the car, the car doors, hatch or trunk may be opened and the car may be started and operated. The vehicle therefore does not require a physical key—a simple button or capacitive touch switch may be used to start and stop the car as long as the valid device can be read and detected by the RFID module.

If no valid device is identified after a predetermined or programmable amount of time, the vehicle variant of the lock system will lock all entry points and the ignition system will shut down (if active). As an example, if a user stops the vehicle, exits, and closes all the doors, once the user is out of range of the RFID reader, the lock system will automatically lock all doors and set the alarm. In this mode any door, hatch or trunk may still be opened from the inside the vehicle without the need for a valid device. If a door is opened from the inside, the alarm system is temporarily disarmed. However, once the door is closed and if there is no valid device present, the doors will re-lock and the alarm will re-arm.

Returning to the device, while the above description discloses a watch implementation of the device, other implementations are possible. Other types of ornamental decorations wearable by a user may be used. In one implementation, a ring, wearable on a user's finger, is used to house the circuitry required by the device. This form factor is eminently suitable for the device's RFID functions. As a physically small housing, the ring implementation of the device is unobtrusive, convenient, and can be eminently useful.

As an RFID device, the device stores pertinent information in the digital storage contained in the device. This pertinent information can be accessed by appropriate RFID readers in the marketplace. The information may include credit card numbers, debit card numbers, driver's license information, passport data, loyalty card information, and critical medical information including drug allergies, prescription medication, and possible interactions.

In one embodiment of the invention, users of the device will preferably register and create an account with an appropriate online-based service in order to use this functionality. It is preferable that the device be designed to operate with a suitable encrypted means for updating its software and the data stored on it. Users may then use this encrypted means to change, update, or add to the data stored on the device. One option for such a data update means would be a USB dongle-style reader/writer that may be sold with each device or which may be sold separately. Another option for updating the data stored on the device would be to use the lock system described above. For this option, the device loads the encrypted codes onto a USB flash drive for a specific lock system and then the user inserts the USB flash drive into the lock system. The lock system then programs the device once the device attempts to activate the lock. This would be a one-time only action. Once the device is programmed, the lock system and USB flash drive would be cleared of this information.

It should be noted that, as an alternative to the above, the device may be updated using other devices and methods than the USB flash drive. As an example, for the ring implementation of the device, a watch device may be used to update the ring device. As well, a smartphone (possibly using Bluetooth 4.0 technology) in conjunction with the lock system described above may also be used to update the device.

Once the user has registered his device with the online-based service, the user can select and de-select retailers or service providers (e.g. credit card service providers) for which the device can be used to pay for transactions. Once registered with a specific retailer, the user can use his device to pay for purchases at a retailer without the need for physical cash or the user's actual credit or debit cards. Once the user has logged in to the online-based service, he can select from a list of available retailers and service providers. If a selected retailer operates a membership based business and the user is a member, the user can then enter his membership account information as well as any other information required to access his account. Alternatively, if the user selects a service provider (e.g. VISA™ or Mastercard™ credit card services from a specific bank), the user can enter his account information for the selected account. Once entered, the account information is then sent to the retailer along with a code unique to the user's device. Once the retailer has confirmed and approved the information, a code linked to the user's account would be provided by the retailer. This code is then uploaded and stored in the device under a reference ID unique to the retailer. This provides a means for the online-based service to identify the device as the source for transactions, thereby allowing the service to track and potentially charge a per-use commission to both the user and the retailer and/or the service provider.

Once loaded onto the device, the availability of the user's account for that retailer on the device would be announced any time the device's RFID function is activated (i.e. the device is scanned). Though its availability is announced to the reader, neither the actual code unique to the retailer nor the user's account information is transmitted unless the user's personal information number (PIN) is provided in some fashion.

The above allows the user to pay for purchases at different merchants and retailers. At a merchant, the user's device is scanned using RFID technology and the merchant's system displays all available services on the device that are accepted by the merchant and allows the user to choose which service they wish to use for that specific transaction. Once a service is selected on the merchant's system, the transaction occurs directly between the user and the service selected with the device no longer being involved. The device's role in the transaction is to simply provide the relevant account information to the service provider or retailer. Once this has been provided and the merchant's system is in communication with the relevant servers and financial institutions, the device's role is at an end for the transaction. While most transaction of this sort would require the user to enter a PIN, one alternative would be for a photo of the user, such as from a passport or driver's license, to be stored on the device. The photo can then be sent from the device to the merchant's system or reader for the merchant to verify the user's identity.

It should be noted that the above-noted approach may be used with any credit, debit or loyalty card.

For the device to be used with government issued identification such as driver's licenses, passports, specific medical information, it is envisioned that agreements will need to be negotiated between the online-based service and the government ID issuing office prior to allowing such information to be formally and officially installed. However, the user may load any personal information, including his contact information, email addresses, driver's license numbers, passport numbers, etc. in a General Personal Information section or the Detailed Personal Information section of the digital storage portion of the device. The General Personal ID section can be accessed without authorization while the Detailed Personal ID section would require a PIN to allow access. Both Personal Information sections can be completely controlled by the user. Only issued identification is controlled by the online-based service. The user can choose to populate his Personal ID section from issued IDs or enter it himself.

Authorized agencies, including police, medical personnel, and government officials, may access issued identification without a PIN if they are the issuing body or if they have been granted permission by the issuing body.

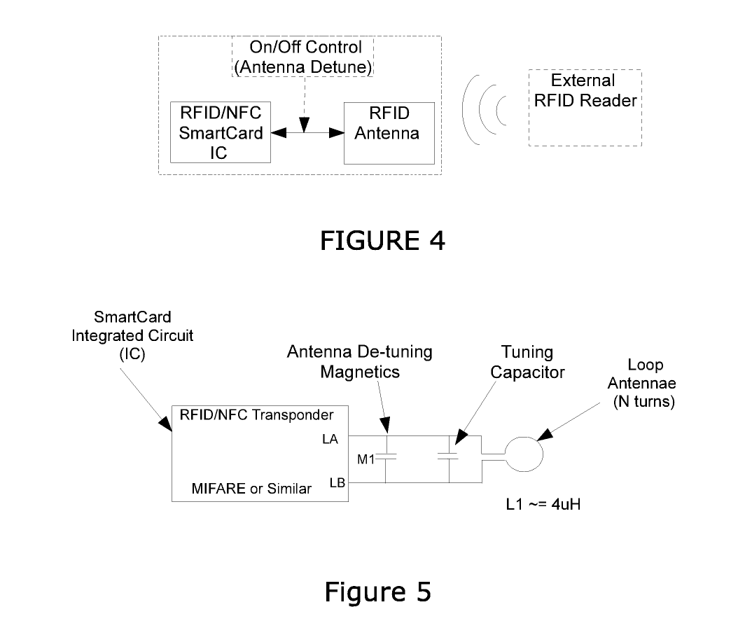

The drawings referred below illustrate embodiments of one aspect of the invention. FIG. 4 is a system block diagram outlining the functional blocks of a ring implementation of the device. As can be seen, An RFID/NFC integrated circuit communicates with an RFID antenna which, in turn, communicates with an external RFID reader.

FIG. 5 is a schematic diagram of the electronic components of the RFID portion of the ring implementation of one aspect of the invention. The SmartCard integrated circuit (containing an RFID/NFC transponder) is coupled to an antenna detuning capacitor. In turn, this is coupled to a tuning capacitor. These are all coupled to a loop antenna. In one embodiment, the loop antenna is contained in the ring implementation of the invention.

It should be noted that NFC refers to Near Field Communications, a short range communications technology which may be used with the present invention. It should further be noted that while the diagrams illustrate a detuning capacitor or detuning magnetics, this feature is optional and need not be implemented in the various embodiments of the invention. The detuning components are optional and do not affect the core workings of the various aspects of the invention.

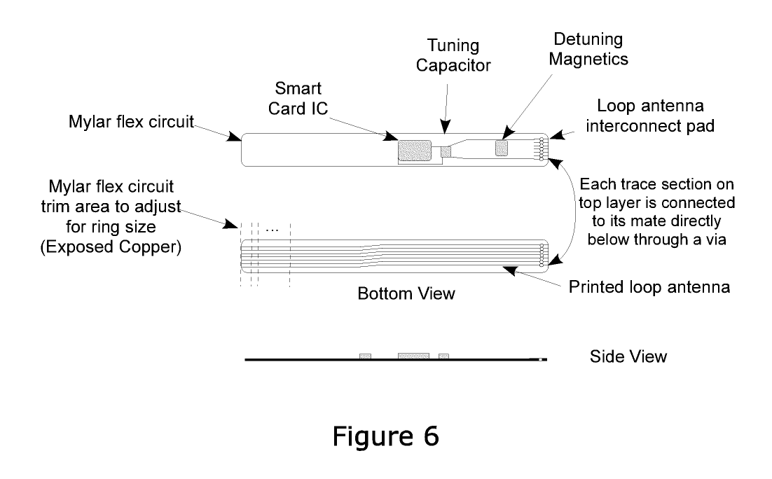

FIG. 6 is a mechanical drawing showing top, bottom and side views of the flex circuit containing the electrical components and the loop antenna prior to formation of the ring implementation of the device. As can be seen, the SmartCard IC, tuning capacitor, detuning magnetics and loop antenna interconnect pad are all placed on a Mylar flexible circuit. Each trace section on the top layer of the flexible circuit is coupled, using a via, to its mate on the bottom layer of the circuit. The Mylar flexible circuit can be trimmed to adjust the size of the circuit to fit within the desired ring size. It should be noted that while Mylar is described in this document as the material used for the flexible circuit, other materials may also be used. Specifically, while a polyester film substrate such Mylar may be used, other materials may be used as base films. These include polyester (PET), polyimide (PI), polyethylene napthalate (PEN), Polyetherimide (PEI), along with various fluropolymers (FEP) and copolymers polyimide films. These materials are preferable due to their blend of advantageous electrical, mechanical, chemical and thermal properties.

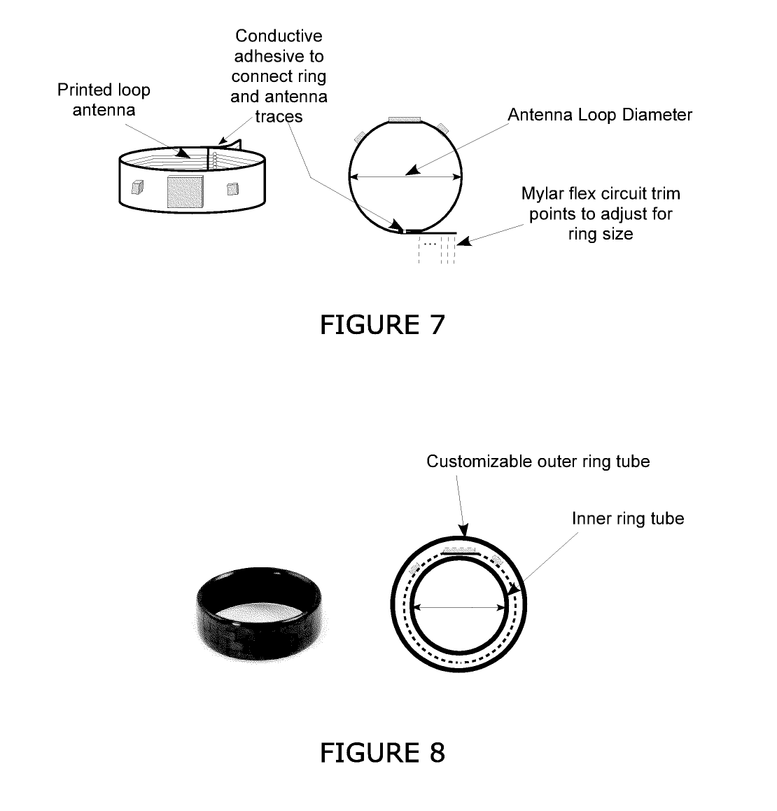

FIG. 7 is a mechanical drawing showing a 3D representation and a 2D cross section of the completed flex circuit formed into the shape of a tube required for the specific ring size being assembled. The printed loop antenna of the ring embodiment of the invention is disposed on an inner side of the ring. A conductive adhesive may be used to connect the ring and the antenna traces as necessary. To adjust for the desired ring size, differing Mylar flexible circuit trim points may be provided. This provides for trim adjustments on the flexible circuit based on ring size.

FIG. 8 is a mechanical drawing showing the completed ring assembly with the flex circuit loop antenna assembly embedded in a ring housing, comprising of a suitable material, including but not limited to, carbon fiber composite, ceramic, and polycarbonate.

It should be noted that there are many different means of assembling these components are possible along with multiple possible shapes and sizes of housings. Included in these possibilities are any and all embodiments in which a SmartCard, RFID, NFC capability is embedded in a ring or other jewelry format, including necklaces, earrings, nose-rings, body studs, eyeglasses, watches, broaches, cufflinks, watches, watch fobs, and wristwatches. These devices in their myriad potential housings may be used for the purposes of personal account access, controlled access, medical information storage, and personal ID such as drivers' licenses, health cards, and passports.

Referring to the schematic in FIG. 5, the ring embodiment of the device is powered in the same way as a standard RFID tag or SmartCard—when the ring's antenna is tuned to the same frequency as a near field antenna signal being transmitted from an RFID reader, an electric field based magnetic coupling transfers power to the ring's circuit via the tuned loop antenna (L1). For user safety and security, an antenna detuning magnetic circuit, variable tuning capacitor, or mechanical or magnetic on/off switch can be used to disable or disconnect the antenna preventing ring operation.

Once sufficient power is collected by the ring's loop antenna the RFID Transceiver device (U1) on the ring device activates automatically and begins to communicate with the reader.

Optionally, for additional user security and control, other versions of the device may contain an optional speaker which beeps to alert the user of a read request, allowing the user, via the optional touch button or sensor on the outer surface of the ring, to allow or deny RFID access requests.

Referring to FIG. 6, the ring embodiment of the device has a flex circuit PCB (printed circuit board), where all components are mounted directly on conductive pads on the Mylar surface. Also on the flex PCB are the conducting traces which form a unique loop antenna arrangement. Due to the nature of the ring shape of the housing, a very efficient loop antenna is formed by converting a series of parallel traces on a flat flex PCB into a ring shape. Antenna traces are printed on one side of the Mylar flex circuit as a parallel series of traces which jog over one trace separation so that when the flex circuit is shaped into a ring or loop, one trace lands on top of the next parallel trace to form a continuous loop antenna. When electrically connected the continuous loop antenna has N number of turns. In the embodiment represented in the drawings, 7 loops are created. Referring to FIG. 7, when the ring is formed the size of the ring diameter can be selected to accommodate the specific ring size being assembled. The loop can be held in place with conductive epoxy or other conductive means.

Since the diameter of the loop antenna affects the inductance of the circuit, and since the size of the loop antenna is different for each finger ring size, external tuning capacitance may be required to assure resonance for each size. This external capacitance or a separate specific detuning device can be used to intentionally detune the ring when automatic RFID communication is not desired.

Referring to FIG. 8 a side cut-away view of the ring device and an isometric view of a finished sample are illustrated. As can be seen from FIG. 8, the completed loop antenna flex circuit is installed between the outer and inner ring blanks, affixed in place and/or potted. The edges of the ring are sealed to thereby form a waterproof container for the flex circuit. Alternatively, the circuit may be totally encapsulated in a ring shaped mold. The ring device may also be equipped with a manual or machine-made wire loop which forms the loop antenna.

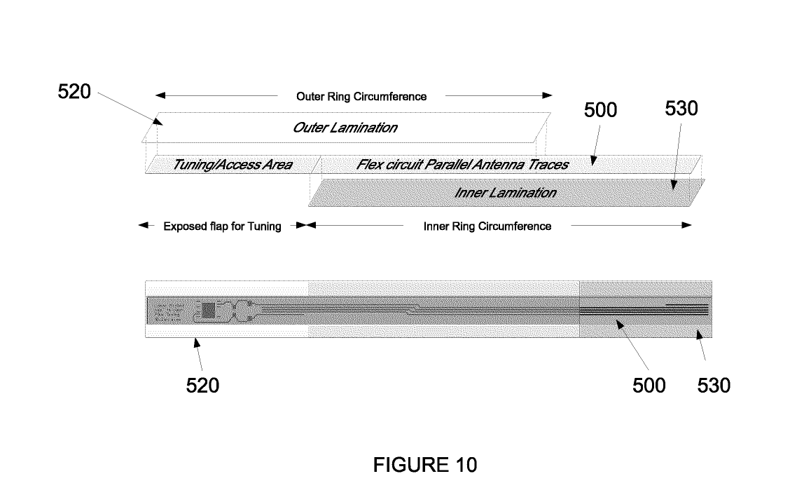

Referring to FIGS. 10-13, additional ring device assembly methods suitable for mass production are schematically illustrated. The methods take advantage of existing roll-to-roll manufacturing processes to enable economies of scale.

Referring to FIG. 10, an offset lamination alignment is shown for an individual circuit (500). The inner (530) and outer (520) laminations are approximately equal in length, adjusting for their thickness and relative positions in the completed assembly, representing approximately the circumference of the finished ring. Their offset from one another represents the area of the flex circuit which will remain accessible after the initial loop formation of the inner lamination (530) in order to make test and tuning possible. The top part of FIG. 10 illustrates the overlap and alignment between the various layers used to arrive at an unrolled ring according to one aspect of the invention. The lower part of FIG. 10 schematically shows the assembled ring prior to rolling.

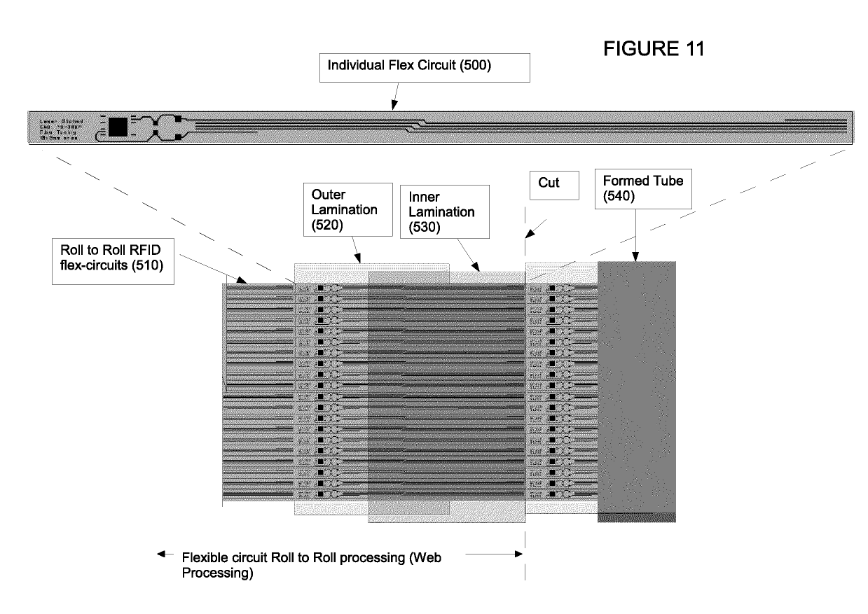

Referring to FIG. 11, the offset lamination alignment is shown for a roll to roll process as well as the tube formation method. In FIG. 11 multiple flexible circuits from the roll to roll process are shown pre-laminated, in the specific and unique offset manner shown in FIG. 10 while the web is flat and prior to forming the loop antenna. The various laminations and their overlap are illustrated in FIG. 11. It should be noted that the lower part of FIG. 11 illustrates multiple circuits and components for the assembly of multiple rings according to one aspect of the invention. Each collection of components can be rolled to form a single ring. A single flexible circuit, prior to being rolled into a ring, is illustrated at the top of FIG. 11. The top of FIG. 11 encompasses the same design concept as that illustrated in FIG. 6 discussed above.

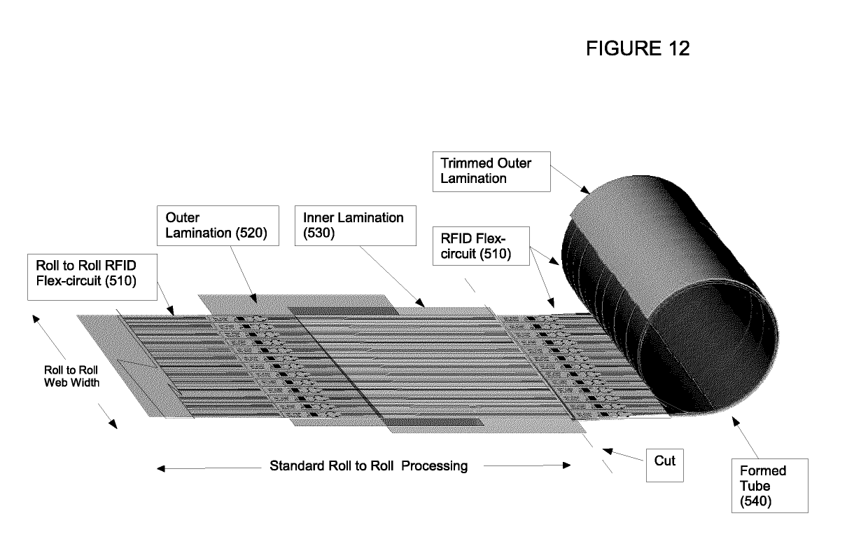

Referring to FIG. 12, an illustration of the rolling of the components to form a batch of multiple individual rings according to one aspect of the invention is provided. Once rolled into a formed tube (540), the inner lamination (530) and the outer lamination (520) that are on either side of the flex-circuit (510) become the encapsulation layers sealing the RFID Flex-circuit and electronics within. It should be noted that one variant of the assembly in FIG. 12 replaces the inner layer lamination with a pre-manufactured tube of the desired ring size, with the tube being long enough to accommodate the entire width of the roll to roll web, onto which the end web segment is rolled.

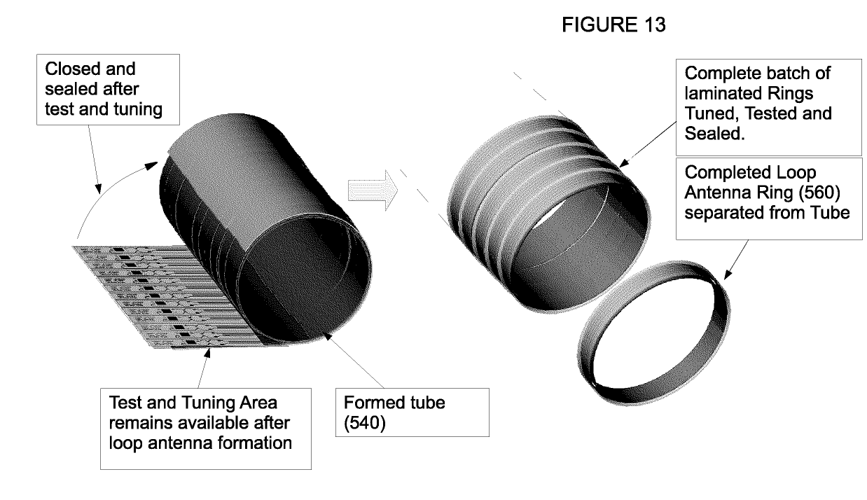

Referring to FIG. 13, both the use of a pre-manufactured tube and the use of a formed tube allow for a tab or flap of the flexible circuit and outer lamination to be left exposed from the resultant tube 540. This allow access to the circuits and to the antenna tuning areas. This access is necessary as testing and tuning cannot occur until the loop antenna has been formed. For a roll-to-roll web width of 304 mm, this method enables a batch size of approximately 90 finished circuits or rings, assuming an individual circuit or ring is 3 mm wide. The batch size may be larger or smaller depending on the width of the roll-to-roll web and the width of the individual circuit. After the batch has been tested and tuned, the flap may be closed and sealed, shielding the electronics on the flex circuit against the elements.

The assembly methods described above for loop tube formation may be accomplished without laminating either the inner or outer surface of the flexible circuit. If lamination is not performed, this results in a bare flexible circuit loop antenna device which may be then be embedded in a subsequent applicable housing or enclosure.

It should be noted that, as FIGS. 12 and 13 illustrated, a single web of multiple components can be rolled to form a tube with multiple individual rings. Each individual ring can then be separated and removed from the tube (see right side of FIG. 13) to result in multiple rings which have been tested and tuned. While not illustrated, one variant of the above method would be to separate each individual ring from the web prior to rolling into rings. For this variant, each ring would be separated from the web and individually rolled into a suitable ring.

To attach the flexible circuit together to form the tube or loops noted above, one method would use a direct soldering of conductive tracks on one end of the flexible circuit to the respective tracks on the landing pad on the another end of the flexible circuit. For this method, the Mylar or other similar substrate material is etched out around a landing pad area to suspend the conductive tracks on the one end of the flexible circuits. On the other end of the flexible circuit, the conductive tracks can then be directly soldered to the tracks of the landing pad area when the loop or tube is formed. The flexible circuit loop is thus electronically coupled forming a continuous loop antenna without the use of vias.

Whether the device is implemented as a ring or as a wristwatch or as another type of ornament, multiple security features may be incorporated to assist in the user identity verification. One option would be for standard biometric data (e.g. facial measurement, finger prints, etc.) to be loaded onto the ring during or as part of the registration\validation process. The biometric data may then be retrieved and confirmed during any subsequent secure service transaction attempt. Alternatively, for a ring implementation of the device, a unique biometric security feature may be used. This biometric security measure is a measurable and consistent shift in the resonant frequency of the ring due to the unique impact of the user's physiology (e.g. parasitic capacitance, inductance of the user's finger/body in contact with the ring antenna) on the antenna of the ring while being worn. A further alternative is the use of a MEMS accelerometer based tilt sensor. The sensor would prevents secure service transactions from occurring unless the device is held in a specific orientation.

The first two options can be implemented in similar manners with the user's unique biometric data being recorded during the registration process of the device. Once the data is collected it can be stored on the device.

To implement the security features, a compatible reader, which can collect the biometric measurement such as capture a finger print, measure facial features, detect resonant frequency shifts, etc., collects the particular biometric parameters. The reader then sends this information to the device at the start of an attempted secure service transaction. The device then compares what the reader has determined for the biometric measurements with what is stored onto the device during the registration process. If the biometric data collected matches the stored data (within a specific tolerance), the secure service transaction is allowed to proceed.

It should be noted that the different security features may need extra steps and devices to implement. To use standard biometric measurements, the device reader should be coupled with a finger print reader, a digital camera, or some other device which is capable of capturing the particular biometric measurements.

To use the above-noted resonant frequency biometric, a specialized reader is required and should be capable of sweeping the readers transmission frequency across an expected frequency range and identify a spike in the antenna loading. This spike in the amount of loading on the antenna represents the resonant frequency of the receiving antenna. The difference between this resonant frequency and the factory set frequency represents the impact due to the wearer and can be used to represent a potential biometric security feature. An example is provided for clarification. The default resonant frequency for a ring implementation of the device may be set at the factory to a frequency of 13.5600 MHz. However, while wearing the device, the parasitic capacitance of the user's finger/body may detune the resonant frequency to 13.51 MHz or 13.65 MHz. The resonant frequency shift of the ring device may be measured by the specialized reader and can be provided to the device. The measured shift can then be used when verifying the user's identity.

The third option uses a MEMS accelerometer or a small mercury switch which can be incorporated into the device's electronics. When the device is used for an attempted secure service transaction, the tilt switch can indicate that the device is being held horizontally. If the device is being held horizontally, the secure service transaction can occur. For a ring implementation of the device, a horizontal position would mean that the finger holding the ring is horizontal relative to the earth, a natural position for a person pointing or touching a panel with the ring on his finger. If the ring device is not pointing horizontally, only specific non-secure data may be accessed.

The ring embodiment detailed above may be used in conjunction with the wristwatch embodiment to arrive at a two-device system. In this embodiment, the ring device may be configured with a speaker, microphone, accelerometer and RFID circuitry. The watch device would be paired with the ring device and all the other functionalities described above would reside in the watch device. As an example, the watch device may function as an RFID reader to provide the RFID capable ring device with suitable wireless power. The ring device would, for this embodiment, not be equipped with an on-board battery but would have an IR LED (for the remote control functionality) and a Bluetooth SOC (system on a chip) for Bluetooth functionality.

The device, whether it is in the form of a wristwatch or a ring, may also be used in a system that may be used in lieu of cash, credit, or debit card payments. The system allows users to purchase cash values that are stored in the device. The cash value stored in the device may be used to pay for purchasers at retailers who have registered for the service. As well, users may transfer cash values purchased to other people's accounts using the device and a suitable reader.

Users of the device may register for the above-noted service using the online-based service. Users with a valid account with the online-based service may purchase “cash” referred to as credit from here on. With sufficient credit purchased, the device may function in a manner similar to a gift card. Amounts may be purchased online or at specific outlets, with the amounts being stored at the user's online account and at the device itself. Regardless of the value purchased, each amount purchased and loaded onto the ring is tagged with a specific transaction number. These transaction numbers and the associated remaining amounts are kept in the ring in a FIFO (first in first out) sequence such that the earliest purchased amounts are used first. When a user completes a transaction at a retailer, the amount of the transaction is subtracted from the amounts stored on the device and a similar operation is executed at the online-based service's server. Thus, there is correspondence between the amount stored on the device and the amount remaining in the user's online account. As noted above, the earliest purchased amounts are used first until the amount left on the device and the user's account reaches zero. If an amount being used in a transaction exceeds the amount left in an amount purchased by the user, other amounts subsequently purchased are then used. As an example, if the user purchased amounts $30, $40, and $50 in that order, then any purchases the user makes will first be applied against the $30 purchased amount, then to the $40 purchased amount and so on. If the user's first purchase amounts to $35, then the $30 purchased amount is depleted and the $5 deficit is applied against the $40 purchased amount to leave the user with $35 left from the $40 purchased amount. Of course, as will be explained below, any purchases or transactions are confirmed and reflected with the user's online account monitored by the online-based service mentioned above.

To further clarify the above, in one example, one $230.54 purchase might made up from 3 different gift cards or amounts purchased by the user and loaded onto the device at different times. The following record for the transaction could be produced:

Total: $230.55, (Merchant account name), description of product, TAG

The TAG field may be used to track transactions such that each TAG field documents how much was removed from each fund purchase transaction by the user. This field may have a format of $Amount,Date.Number. The amount in the field is the amount being used in the transaction. The amount may be followed by a unique number which could incorporate the date that the original transaction occurred on. Thus, a TAG field may have multiple entries with each entry being associated with a specific fund purchase by the user (a fund purchase can be seen as a user's “loading” of the account with funds). Thus, a user may “load” his account multiple times, each instance of which is tracked by the online-based service. The TAG field would detail how much of the funds purchased for each instance is associated with a particular transaction. As an example, a user may purchase $200 for fund purchase instance A and purchase $300 for fund purchase instance B. This means that, for instance A, the user has $200 available and for instance B, the user has $300 available, for a total of $500. For a retail transaction (as an example), with the user paying for an item at a retailer, the TAG for the transaction would detail how much from each instance was taken by the transaction. Thus, if the user purchased $300 worth of goods, the TAG would detail that $200 was taken from instance A and $100 was taken from instance B to make up the total transaction of $300.

To follow on the example given above of a transaction totalling $230.55, the TAG for the transaction may be:

### TAG=122.21,12June2012.12238798,100.00,24Sep2012.123423 55,8.34,21Oct2012.12347654)

These TAG fields could be parsed as follows:

$122.21—12June2012.12238798 (a $200.00 transfer which occurred on 12 Jun. 2012 which had $122.21 left unspent)
$100.00—24Sep2012.12342355 (a $100.00 transfer that is completely used for this transaction)
$8.34—21Oct2012.12347654 (a $100.00 transfer that occurred on 21 Oct. 2012 of which $8.34 is required to complete this transaction, thereby leaving $91.66 in the account and the device at the end of this transaction)

The above assumes the following: that the user performed a fund purchase of $200.00 (on 12 Jun. 2012) of which only $122.21 was left unspent, that the user performed a fund purchase of $100 (on 24 Sep. 2012), none of which has been spent, and that the user performed a fund purchase of $100 on 21 Oct. 2012. The TAG shows that the single transaction totalling $230.55 consists of: $122.21 from the rest of the funds from the fund purchase of $200 on 12 Jun. 2012, $100 from the fund purchase on 24 Sep. 2012, and $8.34 from the fund purchase on 21 Oct. 2012.

If the amount on the device (and on the account) does not contain enough value for a purchase, depending on the configuration, the remainder may be provided via any other available services on the device such as a credit card, debit card, or any other suitable financial service.

To purchase or transfer funds, the user transfers money from his device to a merchant or another device user, via a compatible reader. Compatible readers may be a standalone unit in vending machines, USB dongle devices plugged into a home computer, cash register devices, smartphones, SmartWatches, or iPods™. Other compatible devices may be used as long as those devices allow the user to agree to a specific amount as well as verify the identity/validity of the device, and, eventually, can access the enterprise service application for the online-based service.

To transfer funds for a transaction or purchase, a device reader accesses the enterprise service application for the online-based service and sends the amount to be transferred. The TAG field, along with an optional description, is also sent, essentially tagging the money to say where it came from. Of course, the transfer is performed via a secure connection. Once the data is received by servers at the online-based service end, the server can confirm that the amount is available. Upon confirmation from the online-base service, the amount is transferred from the user's online account to the merchant's account and that amount is removed from both the user's device and his account. With this subtraction from the user's account, the transaction is thus completed. Transactions that cannot be completed, perhaps because a connection to the service application cannot be completed, will remain pending on both the merchant reader and the user's device, until both have made contact with the relevant server. Once the user and the reader are able to connect to the server for the online-based service, the transaction is completed. Pending transactions on the device will place holds on the amounts involved as if the amounts have already been removed and will prevent the use of these funds until the transaction has been completed.

In one implementation, all the user requires to access this service is a valid account with the online-based service. The user does not need to pay a monthly fee or a registration fee in this implementation. A transaction fee is applied when amounts are purchased and loaded on the device. A nominal fee of 1% of the amount paid to the online-based service is envisioned. However, a graduated fee schedule may also be implemented, with the fee decreasing as the amount purchased increases. In one example, a $100 transaction would result in a $1.00 fee while a $500.00 transaction would result in only a $2.00 fee rather than $5.00. The user may decide to place a maximum amount storable on the device.

To add credits to the device (i.e. purchase an amount from the online-based service), the user log onto their online account on the secure enterprise web application for the online-based service and “buys” an amount from any of their attached services, e.g. credit card account, debit card account. This amount is transferred to their online account. If the user is connected to a compatible reader, the amount on their device is updated to reflect the purchase and the transaction is completed. If a compatible device reader is not available, the transaction is pending, and the next time the user connects with a compatible reader which can access his online account, the amount on the device is updated to reflect the purchase. With this, transaction is completed. Every time the device is connected to a suitable reader which is connected to the user's online account, any and all pending transactions are completed before any new transactions are allowed to proceed.

To receive funds from customer transactions, retailers may register a merchant or payee account with the online-based service. A merchant or payee account may require a monthly fee payable to the online-based service. As an alternative, the monthly fee may be waived if the account owner maintains a minimum balance in their merchant or payee account. The main difference between the regular user account and the merchant or payee account is that the funds in the payee account may be transferred to other accounts such as a credit card account, a bank account, or to any number of financial institutions. No per transaction fee is charged to the merchant or the user by the online-based service, though other institutions may charge service fees depending on their agreement regarding transactions or deposits. It should be noted that access to a merchant or payee account is not limited to merchants. Regular users who expect to receive funds using the system may also register for a payee account.

The user can check the status of their merchant or payee account online and can transfer funds that have accumulated from transactions from this payee account to any other attached service such as a credit card, debit card, or to their regular account. No fee is charged by the online-based service for transferring funds from the payee account to another service. The user may also set an automatic transfer of funds from their payee account to a specific service when the account reaches a predefined threshold. As an example, the user may configure his payee account to transfer $500.00 to a personal savings account at a specified banking institution when the payee account reaches $550.00.

As a variant to the above system, the online-based service may choose to pay interest to users and merchants on the amount of funds present in regular or merchant/payee accounts. Monthly interest may only be paid if the account holder maintains a minimum amount in their relevant accounts. The amount of interest provided may be tied to the interest received on the money currently on hold in a trust account at an institution for each currency supported. The trust account stores the money received from regular account transactions until the funds have been used up. This trust account ensures that funds paid for by the user (i.e. amounts purchased by the user) are available when they are requested, thereby ensuring that the financial liability for the regular and merchant/payee accounts are covered. Any excess amount in the trust account after all interest, fees, and costs have been paid is considered profit to the online service and can be withdrawn from the trust account on a daily or monthly basis.

It should be noted that this is not a credit system, since the amounts purchased and stored on the device cannot be accessed for a transaction until that same amount has been paid for by the user. The system is therefore more akin to a closed gift card program. Once an amount has been purchased, the money paid by the user is available to be accessed via the device. The funds paid by the user are placed in the trust account. Since merchant/payee funds can only come from payments made using the device and since the device can only receive amounts from amounts purchased by the user, the system is essentially a closed loop system. With the online-based service receiving the 1% transaction fee noted above, the banking fees required to maintain the bank accounts holding the merchant/payee funds may come from the monthly merchant/payee fees as well as from any interest realized by these bank accounts.

It should further be noted that this is not a currency exchange system either. Each currency supported requires separate regular and merchant/payee accounts as well as associated trust accounts. Thus, a user with a regular account denominated in Canadian dollars would require a separate regular account denominated in US dollars. Each of these regular accounts would have their corresponding trust accounts. A merchant having differently denominated merchant accounts would, of course, have to pay multiple monthly fees.

To transfer funds or amounts from one device to another, one device acts as the sender and another device acts as the receiver. The user of the sender device must have a regular account with a suitable amount available on the regular account. The user of the receiver device must have a payee account registered on the receiver device. Each user would need to access a suitable reader—the sender device would transfer funds from the sender's regular account to the receiver's payee account. The receiver device would thus need to access a suitable reader to receive funds from the receiver's payee account. Clearly, the receiver would need to access his payee account only after the sender has transferred the amounts.

In the time between each device accesses their respective accounts, these transactions would remain pending on both devices. After both devices have connected to the Enterprise Service Application for the online-based service, the transaction is completed. If the receiver takes more than 24 hours to connect to the service application, an email may be sent as a reminder that the payment is pending. On the sender's side, once the user has sent the funds (i.e. the user has had his device access his regular account to transfer the funds), the amount is marked as on hold and cannot be used for other transactions.

To transfer funds from one device to another device with both devices present and a common compatible reader also present, both devices will need to access the common reader. The compatible reader will access both devices and will attempt to contact the online-based service and the accounts of the sender and the receiver. If the reader cannot access the online service to complete the transaction, the transaction on both rings is recorded but marked as pending and holds are placed on the funds. Once either of the receiver or the sender connects to the online server, the pending transaction is recorded at the server and holds are placed on the funds to be transferred at the server side as well. However, the transaction as a whole cannot be completed until both the receiver and the sender have connected to the online-based service server.

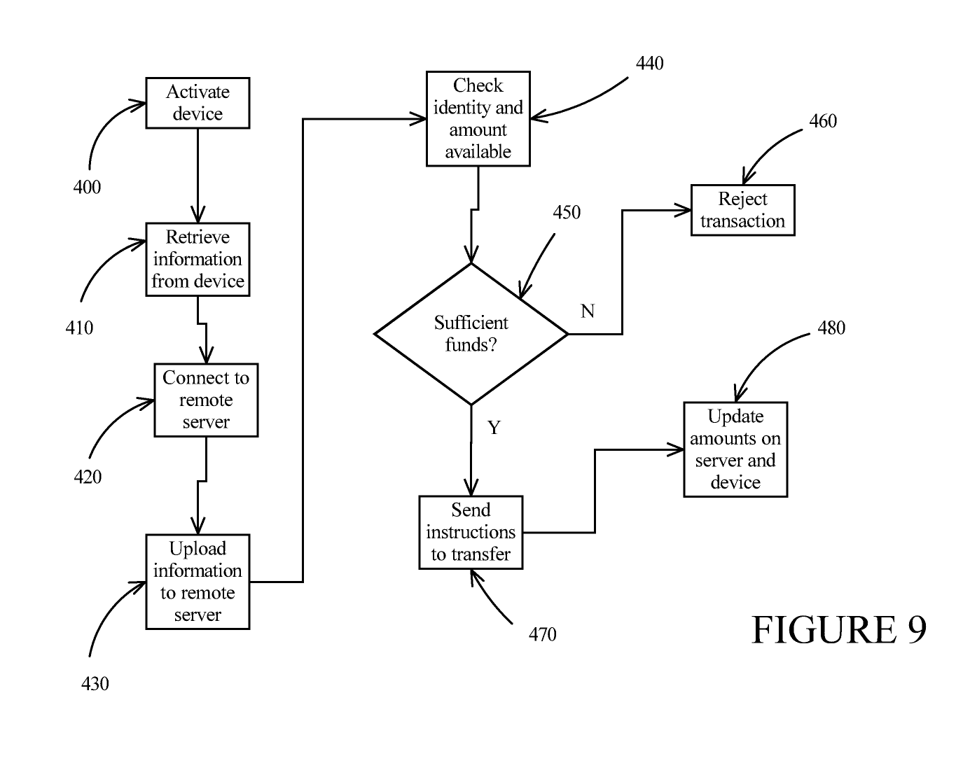

Referring to FIG. 9, a flowchart detailing the steps in a method according to one aspect of the invention is illustrated. The method relates to using the device to pay for a transaction at a retail location using a user's online account with the online-based service. The first step is that of activating the device (step 400). This is done using the device's RFID function—a suitable reader transmits a radio signal of a specific frequency and the radio signal induces a current in an RFID antenna on the device. The induced current is used to power the RFID circuitry in the device. Step 410 in the process is that of retrieving information from the device. The information retrieved from the device by the reader may include the user's account number with the online-based service as well as any other information required by the reader. This information may include identification information which may be needed to confirm the user's identity to either the retailer or to a remote server operated by the online-based service. The next step is that of connecting to the remote server (step 420). The retailer's reader and associated computing device logs into the remote server and prepares to authenticate the user's identity and whether sufficient funds are available on the user's account.

Once the retailer has connected to the remote server, step 430 is that of uploading to the remote server at least some of the information downloaded from the device. This is done to provide the remote server access to the user's account. Next, the user's identity and the amount available to the user is verified (step 440). This is done both at the retailer and at the server and may involve the user entering a PIN or providing some other access granting information. As well, this step may involve the user signalling his agreement to the purchase when he enters his PIN or by touching the amount of the purchase if a touch activated screen is used. Alternatively, this may involve the retailer visually verifying the user's identity using an image of the user's face downloaded from the device. With access to the remote server, the amount available to the user is then checked to determine if the amount is sufficient for the transaction (step 450). If the amount available is insufficient, the transaction is refused (step 460). If the amount available to the user in his account is sufficient for the transaction, step 470 is that of sending instructions to the remote server to transfer the amount for the transaction from the user's account to the merchant/payee's account. The last step (step 480) is that of updating the amounts available to the user. This is done both at the remote server and at the device. The data on the device is therefore updated to reflect the transfer of funds from the user's account to the merchant's account.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A device for storing information, the device comprising:
a nonvolatile storage medium for storing digital information
a antenna for receiving and transmitting the information
transceiver circuitry for receiving and transmitting the information using the antenna
a housing for containing the storage medium and the circuitry, the housing being constructed and arranged as an ornament to be worn by a user;
wherein
the device only transmits the information when the circuitry is activated by a signal received from a preconfigured reader device; and
the information is rewritable by the preconfigured reader device.

2. A device according to claim 1 wherein the housing is configured as one of the following:
a ring constructed and arranged to be worn on a finger of the user;
a pendant;
an ornament for use in a body piercing;
a bracelet;
an earring;
an anklet; and
a wristwatch.

3. (canceled)

4. A device according to claim 1 wherein the device is powered by electricity induced in the antenna by the reader device.

5. A device according to claim 1 further comprising a central processing unit for processing data received through the antenna

6. A device according to claim 5 wherein the data comprises data for identifying the user, the data being compared by the central processing unit with stored data stored on the device to verify the user's identity.

7. A device according to claim 1 wherein the information comprises information relating to the user's financial resources.

8. A device according to claim 7 wherein the information comprises information relating to at least one of:
a user's credit card data;
a user's bank account;
funds available to the user through a predetermined account; and
financial resources purchased by the user.

9. A device according to claim 1 wherein the device is activated only when the device is in physical contact with the reader.

10. A method for receiving payment for a transaction, the method comprising:
a) activating a device used by a user paying for the transaction, the device being activated by a proximity of the device with a reader for the device;
b) retrieving from the device information relating to an identity of the user including an amount of funds available to the user for the transaction;
c) connecting to a remote server and verifying the identity of the user and the amount available to the user;
d) determining if the amount available is suitable for the transaction
e) in the event the amount is suitable,
e1) sending instructions to the remote server to subtract costs for the transaction from the amount available to the user;
e2) sending instructions to the remote server to transfer an amount equal to the costs to a specific merchant's account from the user's account;
e3) subtract costs for the transaction from the amount available to the user and update the information on the device to reflect the costs of the transaction;
wherein
the device comprises:
a nonvolatile storage medium for storing digital information;
a antenna for receiving and transmitting the information;
transceiver circuitry for receiving and transmitting the information using the antenna;
a housing for containing the storage medium and the circuitry, the housing being constructed and arranged as an ornament to be worn by a user;
the device only transmits the information when the circuitry is activated by a signal received from a preconfigured reader device.

11. A method according to claim 10 wherein the user's account contains financial resources purchased by the user specifically for the account.

12. A method according to claim 10 wherein step c) further comprises retrieving information from an account of the user and comparing information regarding the account with the information retrieved from the device.

13. A method according to claim 10 wherein the housing is configured as one of the following:
a ring constructed and arranged to be worn on a finger of the user;
a pendant;
an ornament for use in a body piercing;
a bracelet;
an earring;
an anklet; and
a wristwatch.

14. A method according to claim 10 wherein step c) further comprises receiving a personal identification number from the user.

15. A method according to claim 10 wherein the information relating to an identity of the user includes a digital image of the user, the image being for visual verification of the user's identity.

16. A method for receiving payment for a transaction, the method comprising:
a) activating a device used by a user paying for the transaction, the device being activated by a proximity of the device with a reader for the device;
b) retrieving from the device information relating to an identity of the user including an amount of funds available to the user for the transaction;
c) connecting to a remote server and verifying the identity of the user and the amount available to the user;
d) determining if the amount available is suitable for the transaction
e) in the event the amount is suitable, initiating a transfer of an amount equal to the costs to a specific merchant's account from the user's account and updating the information on the device to reflect the costs of the transaction.

17. A method for unlocking a lock, the method comprising:
a) activating a digital storage device for unlocking the lock when the device is in physical proximity of the lock;
b) querying the storage device for an expected identifier;
c) receiving a received identifier from the device;
d) comparing the received identifier with the expected identifier;
e) in the event the expected identifier matches the received identifier, unlocking the lock;
f) in the event the expected identifier does not match the received identifier, maintaining a locked status of the lock;
wherein the device communicates with the lock in a wireless manner.

18. A method according to claim 17 wherein the expected identifier is one of a plurality of digital keys.

19. A method according to claim 17 wherein the digital storage device comprises:
a nonvolatile storage medium for storing digital information;
a antenna for receiving and transmitting the information;
transceiver circuitry for receiving and transmitting the information using the antenna;
a housing for containing the storage medium and the circuitry, the housing being constructed and arranged as an ornament to be worn by a user;
wherein
the device only transmits the information when the circuitry is activated by a signal received from a preconfigured reader device.

20. A method according to claim 19 wherein the housing is configured as one of the following:
a ring constructed and arranged to be worn on a finger of the user;
a pendant;
an ornament for use in a body piercing;
a bracelet;
an earring;
an anklet; and
a wristwatch.

21. A method according to claim 17 further including the step of activating the lock prior to step a).

22. A method according to claim 21 wherein the lock is activated using a touch activated switch.

23. A method according to claim 17 wherein the lock is installed on a vehicle.

24. A lock system comprising:
an interior touch activated switch;
an exterior touch activated switch;
activation circuitry for activating and communicating with a device using wireless communications, the device being for transmitting a digital key to the lock system when the device is activated;
processing circuitry for receiving the digital key and determining if the digital key is an expected digital key;
a lock, the lock being locked and unlocked by a motor, the motor operating the lock when the processing circuitry determines that the digital key is an expected digital key.

25. A lock system according to claim 24 wherein the activation circuitry only activates the device after either the interior touch activated switch or the exterior touch activated switch is activated.

26. A lock system according to claim 24 wherein the activation circuitry comprises RFID related circuitry.

27. A lock system according claim 24 wherein the activation circuitry comprises Bluetooth related circuitry.

28. A lock system according to claim 24 wherein the internal touch activated switch comprises an interior door handle, the interior door handle being touch sensitive.

29. A lock system according to claim 24 wherein the exterior touch activated switch comprises an exterior door handle, the exterior door handle being touch sensitive.

30. A lock system according to claim 24 further comprising an operating mode control switch, the operating mode control switch being for controlling an operating mode of the lock system.

31. A lock system according to claim 30 wherein the operating mode of the lock system comprises at least one of:
an open mode wherein the lock will open for a predetermined amount of time when either of the interior touch activated switch or the exterior touch switch is activated regardless of whether an expected digital key has been received;
a locked mode wherein an expected digital key is required to be received prior to unlocking the lock from an exterior side and the lock unlocks when the interior touch activated switch is activated;
an off mode wherein the motor is disabled such that a locked or unlocked status of the lock is maintained regardless of digital keys received;
a controlled passage mode wherein an expected digital key is required to have been received to unlock the lock for access from either interior side or exterior side.

32. A lock system according to claim 24 wherein the lock system is installed in a vehicle.

33. Computer readable media having encoded thereon computer readable and computer executable instructions which, when executed, implements a method for receiving payment for a transaction, the method comprising:
a) activating a device used by a user paying for the transaction, the device being activated by a proximity of the device with a reader for the device;
b) retrieving from the device information relating to an identity of the user including an amount of funds available to the user for the transaction;
c) connecting to a remote server and verifying the identity of the user and the amount available to the user;
d) determining if the amount available is suitable for the transaction
e) in the event the amount is suitable, initiating a transfer of an amount equal to the costs to a specific merchant's account from the user's account and updating the information on the device to reflect the costs of the transaction.

34. Computer readable media according to claim 21 wherein the device comprises:
a nonvolatile storage medium for storing digital information;
a antenna for receiving and transmitting the information;
transceiver circuitry for receiving and transmitting the information using the antenna;
a housing for containing the storage medium and the circuitry, the housing being constructed and arranged as an ornament to be worn by a user;
wherein
the device only transmits the information when the circuitry is activated by a signal received from a preconfigured reader device.

35. Computer readable media having encoded thereon computer readable and computer executable instructions which, when executed, implements a method for unlocking a lock, the method comprising:
a) activating a digital storage device for unlocking the lock when the device is in physical proximity of the lock;
b) querying the storage device for an expected identifier;
c) receiving a received identifier from the device;
d) comparing the received identifier with the expected identifier;
e) in the event the expected identifier matches the received identifier, unlocking the lock;
f) in the event the expected identifier does not match the received identifier, maintaining a locked status of the lock;
wherein the device communicates with the lock in a wireless manner.

36. An antenna assembly comprising:
a flat spiral wire loop;
a central area encircled by said wire loop, said central area being devoid of said wire loop;
wherein said central area is configured to operate as a capacitive touch sensor and wherein said central area is unconnected to said wire loop.

37. An antenna assembly according to claim 36 wherein said assembly is located on a padlock wherein said touch sensor is activated to unlock said padlock.

38. An antenna assembly according to claim 37 wherein said padlock comprises other touch sensor areas, said other touch sensor area being unconnected to said antenna assembly.

39. An antenna assembly according to claim 36 wherein said central area is a non-grounded conductive area.

40. An electronically unlockable lock comprising:
a flat spiral wire loop operating as an antenna;
a central area encircled by said wire loop, said central area being devoid of said wire loop;
wherein
said central area is configured to operate as a capacitive touch sensor;
said central area is unconnected to said wire loop;

41. A lock according to claim 40 wherein said lock comprises other touch sensor areas, said other touch sensor area being unconnected to said wire loop.

42. A lock according to claim 40 wherein said lock further comprises a solar cell.

43. A lock according to claim 42 wherein said solar cell is used to trickle charge a battery on said lock.

44. A lock according to claim 40 wherein said lock is configured as a padlock.

45. A method for assembling a multi-layered flexible circuit based device, the method comprising:
a) placing a plurality of layers atop one another to form a web, said plurality of layers including a flexible circuit and an outer lamination;
b) offsetting at least one of said layers such that layers overlap and a portion of at least one layer is exposed from other layers;
c) providing an excess flap of said flexible circuit and said outer lamination after said offsetting;
d) rolling overlapped layers to result in a tube with said flap being exposed from said tube;
e) closing said flap after said flexible circuit has been tested;
wherein
said flap is used for testing and tuning said circuit prior to step e).

46. A method according to claim 45 including a step of dividing said tube into individual flexible circuit based rings.

47. A method according to claim 46 wherein said layers include an inner lamination layer, said inner lamination layer providing an inner circumference of said rings after said tube has been divided into said rings.

48. A method according to claim 46 including a step of placing a pre-manufactured tube of a specific size at one end of said web, an inside of said pre-manufactured tube providing an inner circumference of said rings after said tube has been divided into said rings.

49. A method according to claim 48 wherein said pre-manufactured tube has a size corresponding to a desired ring size.

50. A method according to claim 45 wherein said device comprises:
a nonvolatile storage medium for storing digital information;
a antenna for receiving and transmitting the information;
transceiver circuitry for receiving and transmitting the information using the antenna;
a housing for containing the storage medium and the circuitry, the housing being constructed and arranged as an ornament to be worn by a user;
wherein
the device only transmits the information when the circuitry is activated by a signal received from a preconfigured reader device.
